(19) United States
(12) Patent Application Publication
(10) Pub. No.: US 2007/0224541 A1
(43) Pub. Date: Sep. 27, 2007

(54) Holographic recording medium

(75) Inventors: Rumiko Hayase, Yokohama-shi (JP); Akiko Hirao, Chiba-shi (JP); Kazuki Matsumoto, Kawasaki-shi (JP); Norikatsu Sasao, Tokyo (JP); Takahiro Kamikawa, Yokohama-shi (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/724,318

(22) Filed: Mar. 15, 2007

(30) Foreign Application Priority Data
Mar. 27, 2006 (JP) 2006-086036

(51) Int. Cl. G03C 1/00; G03H 1/04

(52) U.S. Cl. 430/280.1; 430/1; 430/2; 359/3

(57) ABSTRACT

A holographic recording medium has a recording layer, including a matrix formed of a polymer of spiroorthoester of an epoxy compound, a radical-polymerizable compound, and a photoinitiator.

### CROSS-REFERENCE TO RELATED APPLICATIONS

This application is based upon and claims the benefit of priority from prior Japanese Patent Application No. 2006-086036, filed Mar. 27, 2006, the entire contents of which are incorporated herein by reference.

### BACKGROUND OF THE INVENTION

1. Field of the Invention

The present invention relates to a holographic recording medium.

2. Description of the Related Art

A holographic memory that stores data in the form of hologram is capable of high-capacity recording and, thus, attracts attention as a next-generation recording medium. There has been known a photosensitive composition for holographic recording that contains as main components, for example, a radical-polymerizable monomer, a thermoplastic binder resin, a photoinitiator and a sensitizing dye. Such a photosensitive composition for holographic recording is formed into a film and, then, the film is subjected to interference exposure for data recording.

In regions where the light beams are strongly applied, radical polymerization occurs. When the radical polymerization proceeds, the radical-polymerizable monomers are diffused from regions where the light beams are weakly applied toward the regions where the light beams are strongly applied, resulting in a concentration gradient of the radical-polymerizable monomers. Thus, in accordance with intensities of interfered light, differences in densities of the radical-polymerizable monomers are generated and differences in refractive indexes are produced. Following the polymerization of the polymerizable monomer, however, the recording layer may locally contract, which makes it difficult to accurately reconstruct the recorded data.

In order to suppress effect of polymerization contraction due to recording, holographic recording media have been proposed such as a holographic recording medium in which polymerizable monomers are dispersed in a three-dimensional cross-linked polymer matrix (see, for example, JP-A 1999-352303 (KOKAI)), and a holographic recording medium in which photo-polymerizable monomers are dispersed in an epoxy matrix (see, for example, T. J. Trentler et al., Proceedings of SPIE, 2001, Vol. 4296, pp. 259-266). In order to obtain superior properties as a recording layer, it is necessary for the matrix to have some degree of hardness. An epoxy or urethane resin is used for the three-dimensional cross-linked matrix, but such a resin leads to disadvantages such as warping of the substrate and peeling of the recording layer since the resin volumetrically contracts when it is polymerized.

Under the circumstances, proposed is a holographic recording medium using a matrix formed of a polymer of a compound with a ring structure which brings about less volumetric contraction when it is polymerized (see, for example, JP-A 2004-341016 (KOKAI)). However, these compounds with a ring structure have a disadvantage that they are hard to be synthesized.

### BRIEF SUMMARY OF THE INVENTION

According to an embodiment of the present invention, there is provided a holographic recording medium, comprising a recording layer comprising: a matrix formed of a polymer of a spiroorthoester of an epoxy compound; a radical-polymerizable compound; and a photoinitiator.

### BRIEF DESCRIPTION OF THE SEVERAL VIEWS OF THE DRAWING

FIG. 1 is a cross-sectional view showing a transmission holographic recording medium according to an embodiment;

FIG. 2 is a schematic diagram showing a transmission holographic recording-reconstructing apparatus according to an embodiment; and

FIG. 3 is a graph showing reconstructed signals of the holographic recording medium of Example 1 to which angular multiplexing recording has been performed.

### DETAILED DESCRIPTION OF THE INVENTION

Embodiments of the present invention are described below.

The recording layer in the holographic recording medium according to the embodiments of the present invention comprises a matrix formed of a cured product of a spiroorthoester of an epoxy compound, a radical-polymerizable compound, and a photoinitiator. First, respective components contained in the recording layer will be described.

A large majority of polymerizable monomers are known to cause volumetric contraction because they tend to have shorter intermolecular distance when they are polymerized or cured via radical polymerization or cationic polymerization reaction. To the contrary, a spiroorthoester of an epoxy compound has a high density since it has high intermolecular interaction before polymerization, and thus, it is known that the cured product thereof experiences small change in the intermolecular distance or may expand when cured through ring-opening polymerization.

In the embodiments of the present invention, since the recording layer uses the matrix made of a spiroorthoester of an epoxy compound, the recording layer experiences suppressed volumetric change at the time of polymerization, making it possible to avoid warping of the substrate and peeling of the recording layer. Moreover, even if a part of the matrix materials is left unreacted and gradually reacts with time, change in recording sensitivity with time may be suppressed because it is believed that any influence will not be given to a diffusion rate of the radical-polymerizable compound if the density change of the matrix is small.

In the embodiments of the present invention, the spiroorthoester of an epoxy compound is preferably selected from compounds synthesized by the reaction between an epoxy compound and a lactone. Such compounds can be synthesized relatively easily.

Examples of the epoxy compound include phenyl glycidyl ether, allyl glycidyl ether, 2-ethylhexyl glycidyl ether, p-tert-butylphenyl glycidyl ether, 2,3-epoxy-1-propanol, styrene oxide, 1,2:8,9-diepoxy limonene, 1,4-butanediol diglycidyl ether, 1,6-hexanediol diglycidyl ether, 1,8-octanediol diglycidyl ether, ethylene glycol diglycidyl ether, diethylene glycol diglycidyl ether, polyethylene glycol diglycidyl ether, propylene glycol diglycidyl ether, polypropylene glycol diglycidyl ether, neopentyl glycol diglycidyl ether, 1,2,7,8-diepoxy octane, hydroquinone diglycidyl ether, diglycidyl terephthalate, N-glycidyl phthalimide, resorcinol diglycidyl ether, diglycidyl ether of bisphenol A, diglycidyl ether of bisphenol F, diglycidyl ether of hydrogenated bisphenol A, 3,4-epoxycyclohexenylmethyl-3′,4′-epoxycyclohexene carboxylate, tetraglycidyldiaminodiphenylmethane, triglycidyl-p-aminophenol, diglycidylaniline, diglycidyltoluidine, tetraglycidylmetaxylylenediamine, tetraglycidyl-bis-aminomethylcyclohexane, and epoxypropoxypropyl-terminated polydimethyl siloxane.

Of the above epoxy compounds, 1,4-butanediol diglycidyl ether, 1,6-hexanediol diglycidyl ether, 1,8-octanediol diglycidyl ether, ethylene glycol diglycidyl ether, diethylene glycol diglycidyl ether, diglycidyl ether of hydrogenated bisphenol A, 3,4-epoxycyclohexenylmethyl-3′,4′-epoxycyclohexene carboxylate are preferable because of their excellent transparency.

Examples of the lactone include γ-butyrolactone, γ-valerolactone, γ-caprolactone, γ-caprylolactone, γ-laurolactone, γ-palmitolactone, γ-stearolactone, crotolactone, α-angelicalactone, β-angelicalactone, δ-valerolactone, δ-caprolactone, ε-caprolactone, cumarin, and macrocyclic lactone represented by the following general formula (1):

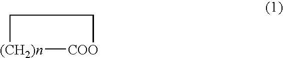

where n is an integer from 8 to 16.

Of the above epoxy lactones, γ-butyrolactone, γ-valerolactone, γ-caprolactone, δ-valerolactone, δ-caprolactone, and ε-caprolactone are preferable because they easily react with epoxy compound.

The spiroorthoester of an epoxy compound can be synthesized by dissolving a lactone and a catalyst such as BF₃OEt₃ in methylene chloride or carbon tetrachloride, and adding drop-wise a solution of an epoxy compound dissolved in an appropriate solvent to the above solution, thereby reacting with each other while controlling reaction rate. At this time, the reaction temperature is generally set to a range from 0 to 30° C. The mixing ratio between the lactone and the epoxy compound is generally set to one equivalent of lactone or more per one equivalent of epoxy group.

Specific examples of the spiroorthoester prepared through reaction between an epoxy compound and a lactone include following compounds. The compound (2) can be prepared by reacting glycidyl ether of bisphenol A with γ-butyrolactone. The compound (3) can be prepared by reacting alicyclic epoxy compound with ε-caprolactone.

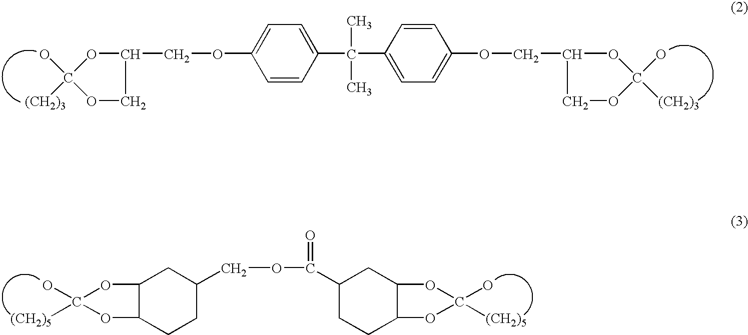

Addition of a cationic polymerization accelerator is preferable for promoting the ring-opening polymerization reaction of the spiroorthoester. Examples of the cationic polymerization accelerator include an onium salt such as a sulfonium salt, an ammonium salt and a phosphonium salt, and an aluminum silanol complex, which are known to the art.

As disclosed in JP-B 1987-15083 (KOKOKU), since the spiroorthoester synthesized from an epoxy compound and a lactone also undergoes ring-opening polymerization in the presence of an organic acid anhydride curing agent, the matrix may be formed using the spiroorthoester and the organic acid anhydride curing agent together. Examples of the organic acid anhydride curing agent include phthalic anhydride, trimellitic anhydride, pyromellitic anhydride, benzophenonetetracarboxylic anhydride, ethyleneglycol bis(anhydrotrimelliate), glycerole tris(anhydrotrimelliate), maleic anhydride, succinic anhydride, tetrahydrophthalic anhydride, methyltetrahydrophthalic anhydride, methylnadic anhydride, dodecenylsuccinic anhydride, hexahydrophthalic anhydride, methylhexahydrophthalic anhydride, methylcyclohexenetetracarboxylic anhydride, polyadipic anhydride, polyazelaic anhydride, and polysebacic anhydride.

Of the above organic acid anhydride curing agents, tetrahydrophthalic anhydride, methyltetrahydrophthalic anhydride, dodecenylsuccinic anhydride, hexahydrophthalic anhydride, methylhexahydrophthalic anhydride, and methylcyclohexenetetracarboxylic anhydride can be preferably used because they are liquid and suitable to prepare a precursor composition for recording layer.

In order to shorten the curing time, a curing accelerator may be added if desired. The curing accelerator is selected from tertiary amines, organic phosphine compounds, imidazole compounds, and their derivatives. More specifically, examples of the curing accelerator include triethanolamine, piperidine, N,N′-dimethylpiperazine, 1,4-diazadicyclo[2.2.2]octane, pyridine, picoline, dimethylcyclohexylamine, dimethylhexylamine, benzildimethylamine, 2-(dimethylaminomethyl)phenol, 2,4,6-tris-(dimethylaminomethyl)phenol, 1,8-diazabicyclo[5.4.0]undec-7-ene (DBU), phenol salt of DBU, trimethylphosphine, triethylphosphine, tributylphosphine, triphenylphosphine, tri(p-methylphenyl)phosphine, 2-methylimidazole, 2,4-dimethylimidazole, 2-ethyl-4-methylimidazole, 2-phenylimidazole, 2-phenyl-4-methylimidazole, and 2-heptaimidazole. Of the above curing accelerators, benzildimethylamine, 2,4,6-tris-(dimethylaminomethyl)phenol, and 1,8-diazabicyclo[5.4.0]undec-7-ene (DBU) are preferably used because of their high curing acceleration effect.

Latent catalysts, such as a boron trifluoride-amine complex, dicyandiamide, organic acid hydrazide, diaminomaleonitrile and derivatives thereof, melamine and derivatives thereof, and amineimide, can also be used.

As the radical-polymerizable compound, a compound having ethylenic unsaturated double bond can be used. The radical-polymerizable compound is selected from, for example, unsaturated carboxylic acids, unsaturated carboxylates, unsaturated carboxylic amides, and vinyl compounds. More specifically, examples of the radical-polymerizable compound include acrylic acid, methyl acrylate, ethyl acrylate, propyl acrylate, butyl acrylate, isobutyl acrylate, 2-ethylhexyl acrylate, octyl acrylate, lauryl acrylate, stearyl acrylate, cyclohexyl acrylate, bicyclopentenyl acrylate, phenyl acrylate, isobornyl acrylate, adamantyl acrylate, methacrylic acid, methyl methacrylate, propyl methacrylate, butyl methacrylate, phenyl methacrylate, phenoxy ethylacrylate, chlorophenyl acrylate, adamantyl methacrylate, isobornyl methacrylate, N-methyl acrylamide, N,N′-dimethyl acrylamide, N,N-methylene bisacrylamide, acryloylmorpholine, vinylpyridine, styrene, bromostyrene, chlorostyrene, tribromophenyl acrylate, trichlorophenyl acrylate, tribromophenyl methacrylate, trichlorophenyl methacrylate, vinyl benzoate, 3,5-dichlorovinyl benzoate, vinyl naphthalene, vinyl naphthoate, naphthyl methacrylate, naphthyl acrylate, N-phenylmethacrylamide, N-phenylacrylamide, N-vinylpyrrolidinone, N-vinylcarbazole, 1-vinylimidazole, bicyclopentenyl acrylate, 1,6-hexanediol diacrylate, pentaerythritol triacrylate, pentaerythritol tetraacrylate, dipentaerythritol hexaacrylate, diethyleneglycol diacrylate, polyethyleneglycol diacrylate, polyethyleneglycol dimethacrylate, tripropyleneglycol diacrylate, propyleneglycol trimethacrylate, diallyl phthalate, and triaryl trimellitate.

Of the above radical-polymerizable compounds, bromostyrene, chlorostyrene, tribromophenyl acrylate, trichlorophenyl acrylate, tribromophenyl methacrylate, trichlorophenyl methacrylate, vinyl benzoate, 3,5-dichlorovinyl benzoate, vinyl naphthalene, vinyl naphthoate, naphthyl methacrylate, naphthyl acrylate, N-vinylpyrrolidinone, and N-vinylcarbazole are preferably used because they bring about large refractive index variation through polymerization.

The radical-polymerizable compound is preferably compounded in a ratio of 1 to 50% by weight, more preferably 3 to 30% by weight, based on the entire recording layer. If the ratio of the radical-polymerizable compound is smaller than 1% by weight, it is difficult to provide a sufficient change in refractive index in the recording layer. If the ratio exceeds 50% by weight, excessively large volumetric contraction of the recording layer may be brought about, resulting in lowered resolution.

The photoinitiator can be selected from, for examples, imidazole derivatives, organic azide compounds, titanocenes, organic peroxides, and thioxanthone derivatives. More specifically, examples of the photoinitiator include benzil, benzoin, benzoin ethyl ether, benzoin isopropyl ether, benzoin butyl ether, benzoin isobutyl ether, 1-hydroxycyclohexyl phenyl ketone, benzil methyl ketal, benzil ethyl ketal, benzil methoxyethyl ether, 2,2′-diethyl acetophenone, 2,2′-dipropyl acetophenone, 2-hydroxy-2-methyl propiophenone, p-tert-butyl trichloroacetophenone, thioxanthone, 2-chlorothioxantone, isopropylthioxantone, diphenyl(2,4,6-trimethylbenzoil)phosphine oxide, 3,3′, 4,4′-tetra(t-butylperoxycarbonyl)benzophenone, 2,4,6-tris(trichloromethyl)-1,3,5-triazine, 2-[(p-methoxyphenyl)ethylene]-4,6-bis(trichloromethyl)-1,3,5-triazine, 2-[(p-methoxyphenyl)ethylene]-4,6-bis(trichloromethyl)-1,3,5-triazine, Irgacure® 149, 184, 369, 651, 784, 819, 907, 1700, 1800, 1850, and so forth, available from Ciba Specialty Chemicals, di-t-butyl peroxide, di-cumyl peroxide, t-butyl cumyl peroxide, t-butyl peroxyacetate, t-butyl peroxyphthalate, t-butyl peroxybenzoate, acetyl peroxide, isobutyryl peroxide, decanoyl peroxide, lauroyl peroxide, benzoyl peroxide, t-butyl hydroperoxide, cumene hydroperoxide, methyl ethyl ketone peroxide, and cyclohexanone peroxide.

Of the above photoinitiators, 2-chlorothioxantone, isopropylthioxantone, diphenyl(2,4,6-trimethylbenzoil)phosphine oxide, and Irgacure® 369, 784, 819, and 907, available from Ciba Specialty Chemicals, are preferably used because of their high sensitivity.

The photoinitiator is preferably compounded in a ratio of 0.1 to 10% by weight, more preferably 0.2 to 6.0% by weight, based on the entire recording layer. If the ratio of the photoinitiator is smaller than 0.1% by weight, it is difficult to provide a sufficient change in refractive index in the recording layer. If the ratio exceeds 10% by weight, light absorption would become excessively high, resulting in lowered resolution.

It is also possible to add to the recording layer a sensitizing dye such as cyanine, merocyanine, xanthene, cumarin and eosine, as well as a silane coupling agent and a plasticizer as necessary.

A holographic recording medium according to the embodiments of the present invention can be manufactured by a method below. For example, a method can be used which comprises applying a precursor solution for recording layer to substrate by casting or spin-coating and polymerizing the matrix precursor to form the recording layer. Another method may be used which comprises arranging two substrates in a manner to face each other with a resin spacer interposed therebetween, injecting the precursor solution for recording layer into the gap between the two substrates and polymerizing the matrix precursor to form the recording layer. A glass substrate or a plastic substrate can be used as the substrate.

The polymerization reaction for forming the matrix may proceeds even under room temperature, but the polymerization reaction may be promoted by heating the precursor to about 40 to 120° C., provided that the radical-polymerizable monomers are not polymerized. The thickness of the recording layer may preferably be set to 20 μm to 2 mm, more preferably 50 μm to 1 mm. Where the thickness of the recording layer is smaller than 20 μm, it is difficult to provide a sufficient memory capacity. If the thickness of the recording layer exceeds 2 mm, sensitivity the recording layer may be lowered.

In the embodiments of the present invention, control of density of the recording layer allows control of diffusion of the radical-polymerizable monomers, making it possible to perform precise hologram recording.

In the embodiments of the present invention, it is important that the recording layer has a moderate hardness. If the recording layer is too soft, the radical-polymerizable monomers can readily diffuse, which permits fast polymerization reaction but leads to occurrence of errors where recorded signals can not be retained. If the recording layer is too hard, the radical-polymerizable monomers can diffuse only slowly, which takes a longer time for recording. The recording layer preferably exhibits rubber elasticity at room temperature, and has durometer hardness of A45 or more and A85 or less, preferably A50 or more and A80 or less, and more preferably A55 or more and A75 or less. If the durometer hardness is A45 or more, volume change of the recording layer through diffusion of the radical-polymerizable compounds can be suppressed. If the durometer hardness is A85 or less, the diffusion of the radical-polymerizable compounds is not excessively disturbed, which is advantageous to retain recording sensitivity and diffraction efficiency. The durometer hardness should be measured according to JIS K 6253 (Determination of rubber hardness) or another method corresponding to the above standard, for example, ISO 7619-1:2004.

In the embodiments of the present invention, in order to appropriately adjust the durometer hardness of recording layer, it is especially preferable to use an epoxy compound with an alkylene chain having 4 to 8 carbon atoms in synthesizing a spiroorthoester of an epoxy compound, the matrix precursor.

For a holographic recording medium according to an embodiment, holographic recording is carried out by making information beam and reference beam interfere with each other within the recording layer. Hologram (holography) to be recorded may be any of the transmission hologram (transmission holography) and the reflection hologram (reflection holography). The method for bringing about interference between the information beam and the reference beam may be any of a two-beam interference method and a collinear interference method.

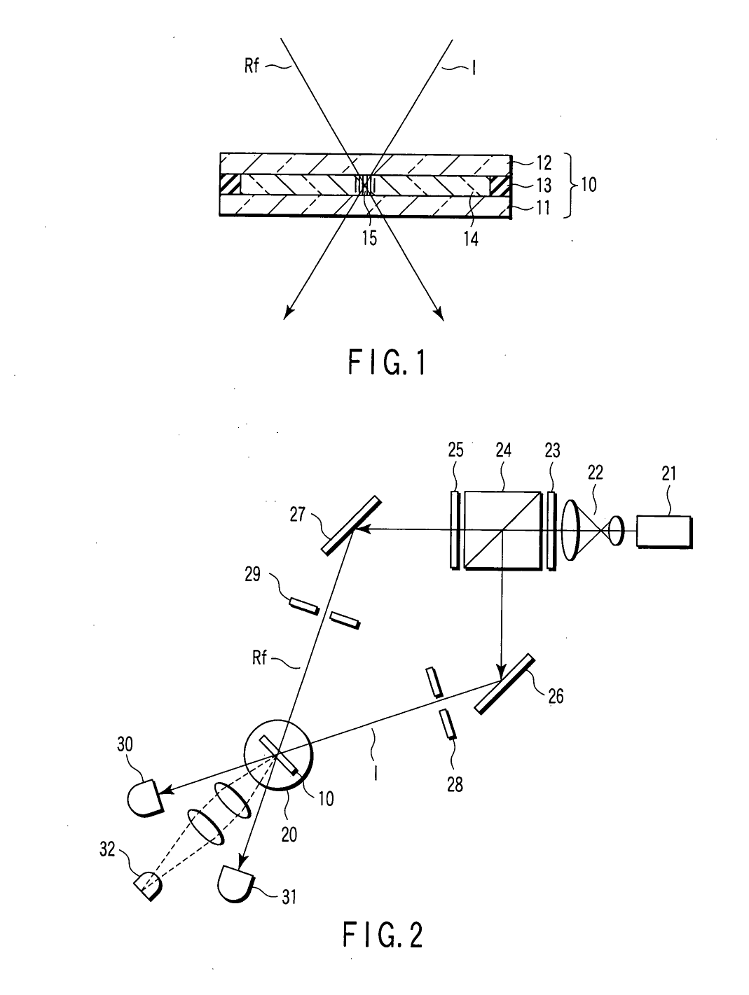

FIG. 1 is a cross-sectional view showing a transmission holographic recording medium 10 used in two-beam interference holography according to an embodiment. The holographic recording medium 10 comprises a pair of transparent substrates 11, 12 arranged with a spacer 13 interposed therebetween to form a prescribed gap, and a recording layer 14 disposed in the gap between the transparent substrates 11 and 12. The recording layer 14 contains a matrix formed of a polymer of spiroorthoester of an epoxy compound, a radical-polymerizable compound, and a photoinitiator. The transmission holographic recording medium 10 is irradiated with the information beam I and the reference beam Rf. The information beam I and the reference beam Rf cross and interfere with each other in the recording layer 14 to form a transmission hologram in a refractive index-modulated region 15.

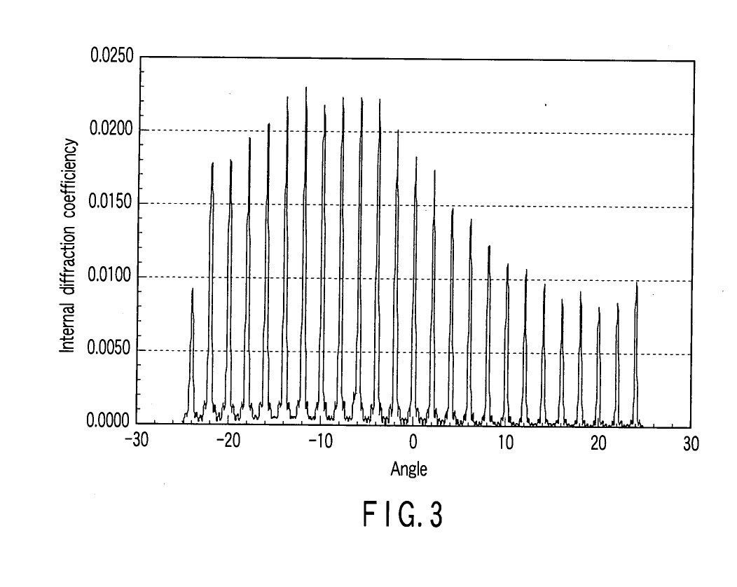

FIG. 2 is a schematic diagram showing an example of a transmission holographic recording-reconstructing apparatus according to an embodiment. The holographic recording-reconstructing apparatus uses the transmission two-beam interference method. The holographic recording medium 10 is supported by a rotary stage 20. The light source device 21 may be any light source that emits light capable of interfering in the recording layer 14 of the holographic recording medium 10. Linearly polarized laser light is desirable in view of coherency. Examples of the laser include a semiconductor laser, a He—Ne laser, an argon laser and a YAG laser. The light beam emitted from the light source device 21 is incident on a polarization beam splitter 24 via a beam expander 22 and a rotating optical element 23. The beam expander 22 expands the light beam emitted from the light source device 21 so as to have a diameter adapted for the holographic recording. The rotating optical element 23 rotates the plane of polarization of the expanded light beam through the beam expander 22 so as to generate a light beam including an S-polarized component and a P-polarized component. As the rotating optical element 23, a half-wave plate or a quarter-wave plate, for example, may be used.

Of the light beam having passed, through the rotating optical element 23, the S-polarized component is reflected by the polarization beam splitter 24 which is used as the information beam I, and the P-polarized component is transmitted through the polarization beam splitter 24 which is used as the reference beam Rf. It should be noted that the rotation direction of the plane of polarization of the light beam incident on the polarization beam splitter 24 is controlled by the rotating optical element 23 so as to make the intensities of the information beam I and the reference beam Rf equal to each other at the position of the recording layer 14 in the holographic recording medium 10.

The information beam I reflected by the polarization beam splitter 24 is reflected by a mirror 26, and then passes through an electromagnetic shutter 28 to be applied to the recording layer 14 of the holographic recording medium 10 supported by the rotary stage 20.

On the other hand, the reference beam Rf having passed through the polarization beam splitter 24 is incident on a rotating optical element 25 where the polarization direction thereof is rotated by 90° into an S-polarized light. The reference beam Rf is reflected by a mirror 27, and then passes through an electromagnetic shutter 29 to be applied to the recording layer 14 of the holographic recording medium 10 supported by the rotary stage 20 in such a manner that the reference beam Rf crosses with the information beam I therein. As a result, a transmission hologram is formed in the refractive index-modulated region 15.

In order to reconstruct the recorded data, the electromagnetic shutter 28 is closed so as to shut off the information beam I and to allow the reference beam Rf alone to be applied to the transmission hologram (refractive index-modulated region 15) formed within the recording layer 14 of the holographic recording medium 10. When passing through the holographic recording medium 10, the reference beam Rf is partly diffracted by the transmission hologram. The diffracted light is detected by a photodetector 30. A photodetector 31 for monitoring the light passing through the holographic recording medium 10 is also arranged.

In order to polymerize unreacted radical-polymerizable compounds after the holographic recording so as to make the recorded hologram stable, an ultraviolet light source device 32 and an optical system for ultraviolet light irradiation may be provided to perform flood exposure as shown in the drawing. Any light source that emits light capable of polymerizing the unreacted radical-polymerizable compound may be used as the ultraviolet light source device 32. In view of efficiency for emitting ultraviolet light, it is desirable to use, for example, a xenon lamp, a mercury lamp, a high-pressure mercury lamp, a mercury xenon lamp, a gallium nitride-based light emitting diode, a gallium nitride-based semiconductor laser, an excimer laser, third harmonic generation (355 nm) of a Nd:YAG laser, and a fourth harmonic generation (266 nm) of a Nd:YAG laser as the ultraviolet light source 32.

The holographic recording medium according to the present invention can be suitably used for multiplexing recording. The multiplexing recording may be either transmission-type or reflection-type.

### EXAMPLES

The present invention will be described in more detail in reference to Examples bellow. In the following Examples, any spiroorthoester of an epoxy compound, the matrix precursor, represented by the following chemical formulas A-1, A-2, A-3 and A-4 was used. In addition, a compound represented by the following chemical formula B-1 was used as the curing agent in Example 5.

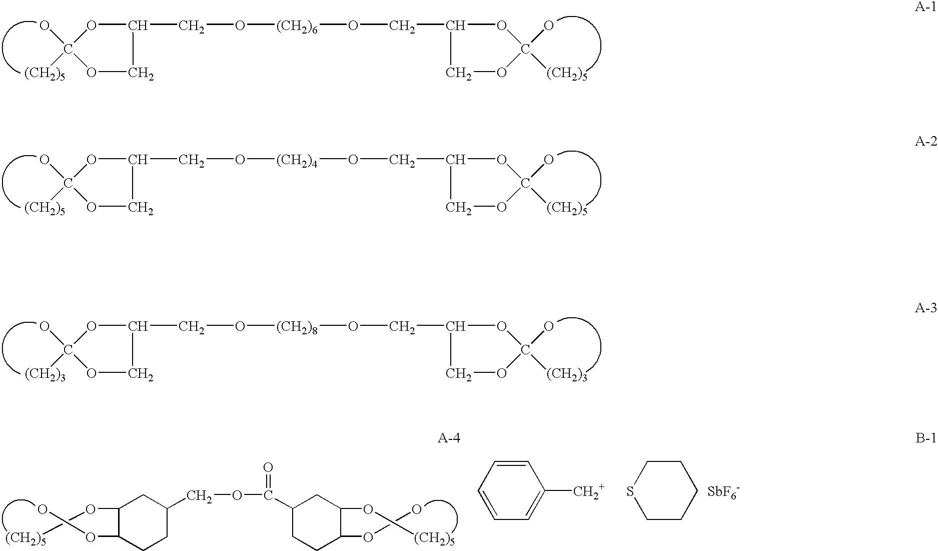

### Example 1

Mixed were 22.9 g of a spiroorthoester represented by the chemical formula A-1, 16.8 g of hexahydrophthalic anhydride as a curing agent, 2.48 g of N-vinyl carbazole as a radical-polymerizable compound, and 2.48 g of Irgacure® 369 (manufactured by Ciba Specialty Chemicals Inc.) as a photoinitiator to prepare a solution. To the solution, 0.40 g of 2,4,6-tris(dimethylaminomethyl)phenol as a curing promoter was added and then defoamed to prepare a precursor solution for recording layer.

The precursor solution was injected into the gap between two glass substrates arranged with a spacer made of a polytetrafluoroethylene (PTFE) sheet interposed therebetween. The resultant structure was stored for 24 hours at 60° C. under a condition shielded from light to fabricate a test piece of a holographic recording medium having a recording layer with a thickness of 200 μm.

The test piece was disposed on the rotary stage 20 of the holographic recording-reproducing apparatus shown in FIG. 2 to record a hologram. A semiconductor laser having a wavelength of 405 nm was used as the light source device 21. The light spot size on the test piece was 5 mmφ for each of the information beam I and the reference beam Rf, and the intensity of the recording light was adjusted to 5 mW/cm² based on the sum of the information beam and the reference beam.

After the holographic recording, the electromagnetic shutter 28 was closed to shut off the information beam I so as to allow the test piece to be irradiated with the reference beam Rf alone. As a result, diffracted light from the test piece was detected, supporting that a transmission hologram was recorded in the test piece. The internal diffraction coefficiency was saturated at 85% after the test piece was irradiated with light of 100 mJ/cm². The internal diffraction efficiency (n) was calculated by the following formula: η=I_{d}/(Iₜ+I_{d}), where I_{d} denotes the light intensity detected with the photodetector 30 and Iₜ denotes the light intensity detected with the photodetector 31 when the holographic recording medium 12 was irradiated with the reference beam Rf alone.

Recording performance of the holographic recording medium was evaluated based on M/# (M number) expressing a recording dynamic range. The M/# is defined by the formula given below using the internal diffraction efficiency η:

$$M / \# = {\sum }_{i = 1}^{n} \sqrt{{η}_{i}}$$

where ηᵢ denotes the internal diffraction efficiency of the i-th hologram in the case where angular multiplexing recording-reconstructing of n-pages of holograms is carried out until the recording is made impossible to the same region within the recording layer of the holographic recording medium. The angular multiplexing recording-reconstructing was carried out by irradiating the holographic recording medium 20 with prescribed light while rotating the rotary stage 20. The holographic recording medium having a high value of M/# has a high recording dynamic range, and thus is excellent in the multiplex recording performance.

FIG. 3 is a graph showing reconstructed signals when the angular multiplexing recording-reconstructing was carried out using the holographic recording medium for this Example. In this Example, the test piece was rotated by 2° using the rotary stage 20 every time one page was recorded, and the particular operation was repeated so as to perform angular multiplexing holographic recording for 25 pages in total within a range of −24° to +24°. A light irradiance amount En (mJ/cm²) for hologram of n-th page was a value calculated by the formula: En=70×exp((n−1)/10). Further, after the light was shielded and the holographic recording medium was left to stand for 5 minutes for awaiting the completion of the reaction, the diffraction efficiency n was measured by rotating the rotary stage 20 so as to obtain the value of M/#. The value of M/# for the holographic recording medium for this Example was found to be 11.

After the holographic recording medium was stored at 25° C. for three months with the light shielded, the medium was subjected to the same measurement as above. The value of M/# was found to be 11, supporting that there was no change.

On the other hand, the precursor solution prepared above was injected into a silicon mold, and was heated at 60° C. for 24 hours to be cured. The volumetric contraction factor was found to be 0.6%. The durometer hardness of the cured product was found to be 73.

### Example 2

Mixed were 21.5 g of a spiroorthoester represented by the chemical formula A-2, 26.0 g of dodecenyl succinic anhydride as a curing agent, 5.28 g of 2,4,6-tribromophenyl acrylate as a radical-polymerizable compound, and 0.26 g of Irgacure® 784 (manufactured by Ciba Specialty Chemicals Inc.) as a photoinitiator to prepare a solution. To the solution, 0.53 g of dimethylbenzylamine as a curing promoter was added and then defoamed to prepare a precursor solution for recording layer.

A holographic recording medium is fabricated by the similar procedures to Example 1. When the internal diffraction coefficiency was measured, it was saturated at 75% after the test piece was irradiated with light of 60 mJ/cm². When angular multiplexing recording was carried out by the similar procedures to Example 1, M/# was found to be 8. After the holographic recording medium was stored at 25° C. for three months with the light shielded, the value of M/# was found to be 8, supporting that there was no change.

On the other hand, the precursor solution prepared above was injected into a silicon mold, and was heated at 60° C. for 24 hours to be cured. The volumetric contraction factor was found to be 0.6%. The durometer hardness of the cured product was found to be 78.

### Example 3

Mixed were 21.5 g of a spiroorthoester represented by the chemical formula A-3, 26.0 g of dodecenyl succinic anhydride as a curing agent, 8.91 g of 2,4,6-tribromophenyl acrylate as a radical-polymerizable compound, and 2.97 g of Irgacure® 369 (manufactured by Ciba Specialty Chemicals Inc.) as a photoinitiator to prepare a solution. To the solution, 0.40 g of 1,8-diazabicyclo[5.4.0]undec-7-ene (DBU) as a curing promoter was added and then defoamed to prepare a precursor solution for recording layer.

A holographic recording medium is fabricated by the similar procedures to Example 1. When the internal diffraction coefficiency was measured, it was saturated at 80% after the test piece was irradiated with light of 40 mJ/cm². When angular multiplexing recording was carried out by the similar procedures to Example 1, M/# was found to be 12. After the holographic recording medium was stored at 25° C. for three months with the light shielded, the value of M/# was found to be 12, supporting that there was no change.

On the other hand, the precursor solution prepared above was injected into a silicon mold, and was heated at 60° C. for 24 hours to be cured. The volumetric contraction factor was found to be 0.5%. The durometer hardness of the cured product was found to be 65.

### Example 4

Mixed were 24.0 g of a spiroorthoester represented by the chemical formula A-4, 26.0 g of dodecenyl succinic anhydride as a curing agent, 9.34 g of N-vinylcarbazole as a radical-polymerizable compound, and 3.13 g of Irgacure® 369 (manufactured by Ciba Specialty Chemicals Inc.) as a photoinitiator to prepare a solution. To the solution, 0.50 g of 2,4,6-tris(dimethylaminomethyl)phenol as a curing promoter was added and then defoamed to prepare a precursor solution for recording layer.

A holographic recording medium is fabricated by the similar procedures to Example 1. When the internal diffraction coefficiency was measured, it was saturated at 80% after the test piece was irradiated with light of 80 mJ/cm². When angular multiplexing recording was carried out by the similar procedures to Example 1, M/# was found to be 14. After the holographic recording medium was stored at 25° C. for three months with the light shielded, the value of M/# was found to be 14, supporting that there was no change.

On the other hand, the precursor solution prepared above was injected into a silicon mold, and was heated at 60° C. for 24 hours to be cured. The volumetric contraction factor was found to be 0.7%. The durometer hardness of the cured product was found to be 81.

### Example 5

Mixed were 21.5 g of a spiroorthoester represented by the chemical formula A-4, 1.71 g of a curing agent represented by the chemical formula B-1, 4.10 g of 2,4,6-tribromophenyl acrylate as a radical-polymerizable compound, and 1.37 g of Irgacure® 369 (manufactured by Ciba Specialty Chemicals Inc.) as a photoinitiator. Then the solution was defoamed to prepare a precursor solution for recording layer.

A holographic recording medium is fabricated by the similar procedures to Example 1. When the internal diffraction coefficiency was measured, it was saturated at 80% after the test piece was irradiated with light of 50 mJ/cm². When angular multiplexing recording was carried out by the similar procedures to Example 1, M/# was found to be 10. After the holographic recording medium was stored at 25° C. for three months with the light shielded, the value of M/# was found to be 10, supporting that there was no change.

On the other hand, the precursor solution prepared above was injected into a silicon mold, and was heated at 60° C. for 24 hours to be cured. The volumetric contraction factor was found to be 0.5%. The durometer hardness of the cured product was found to be 84.

### Comparative Example 1

Mixed were 10.1 g of 1,4-butanediol diglycidyl ether instead of a spiroorthoester, 26.0 g of dodecenyl succinic anhydride as a curing agent, 4.01 g of 2,4,6-tribromophenyl acrylate as a radical-polymerizable compound, and 0.20 g of Irgacure® 784 (manufactured by Ciba Specialty Chemicals Inc.) as a photoinitiator to prepare a solution. To the solution, 0.53 g of dimethylbenzylamine as a curing promoter was added and then defoamed to prepare a precursor solution for recording layer.

A holographic recording medium is fabricated by the similar procedures to Example 1. It was observed that wrinkles were caused on the outer periphery of the medium, which was due to contraction of the recording layer. The phenomenon was what had not been found in the holographic recording medium in Examples of 1 to 5.

When the internal diffraction coefficiency was measured, it was saturated at 70% after the test piece was irradiated with light of 80 mJ/cm². When angular multiplexing recording was carried out by the similar procedures to Example 1, M/# was found to be 6. After the holographic recording medium was stored at 25° C. for three months with the light shielded, the value of M/# was lowered to 3.

On the other hand, the precursor solution prepared above was injected into a silicon mold, and was heated at 60° C. for 24 hours to be cured. The volumetric contraction factor was found to be 3.8%.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A holographic recording medium, comprising a recording layer comprising:
a matrix formed of a polymer of a spiroorthoester of an epoxy compound;
a radical-polymerizable compound; and
a photoinitiator.

2. The medium according to claim 1, wherein the spiroorthoester of the epoxy compound is a reaction product of the epoxy compounds and a lactone.

3. The medium according to claim 1, wherein the epoxy compound has an alkylene chain having 4 to 8 carbon atoms.

4. The medium according to claim 1, further comprising a curing agent.

5. The medium according to claim 4, wherein the curing agent is an organic acid anhydride.

6. The medium according to claim 1, further comprising a curing accelerator.

7. The medium according to claim 1, further comprising a cationic polymerization accelerator.

8. The medium according to claim 1, wherein cationic polymerization accelerator comprises a material selected from the group consisting of a sulfonium salt, an ammonium salt, a phosphonium salt, and an aluminum silanol complex.

9. The medium according to claim 1, wherein the recording medium has durometer hardness ranging A45 or more and A85 or less.

10. The medium according to claim 1, wherein the radical-polymerizable compound is contained in the recording layer in a ratio of 1 to 50% by weight.

11. The medium according to claim 1, wherein the photoinitiator is contained in the recording layer in a ratio of 0.1 to 10% by weight.

12. The holographic recording medium according to claim 1, wherein the recording layer is sandwiched between a pair of transparent substrates.

13. The medium according to claim 2, wherein the spiroorthoester of the epoxy compound is selected from the group consisting of the compounds represented by the following formulas: [chemical structure]
